(19) United States
(12) Patent Application Publication
(10) Pub. No.: US 2005/0092169 A1
(43) Pub. Date: May 5, 2005

(54) Control device for a hydraulic lifting arrangement

(75) Inventor: Martin Raadkjaer Joergensen, Soenderborg (DK)

Correspondence Address: MCCORMICK, PAULDING & HUBER LLP, CITY PLACE II, 185 ASYLUM STREET, HARTFORD, CT, 06103, US

(73) Assignee: Sauer-Danfoss ApS, Nordborg (DK)

(21) Appl. No.: 10/970,766

(22) Filed: Oct. 21, 2004

(30) Foreign Application Priority Data
Oct. 23, 2003 (DE) 103 49 714.5

(51) Int. Cl. F15B 11/08

(52) U.S. Cl. 91/445

(57) ABSTRACT

The invention concerns a control device for a hydraulic lifting arrangement with a drive in the form of a hydraulic motor, which has a first working connection and a second working connection, a pressure connection and a tank connection, and a control valve, which is connected with the pressure connection and the tank connection on the one side and with the first working connection via a first working pipe and with the second working connection via a second working pipe, each working pipe comprising a stop valve that can be opened.

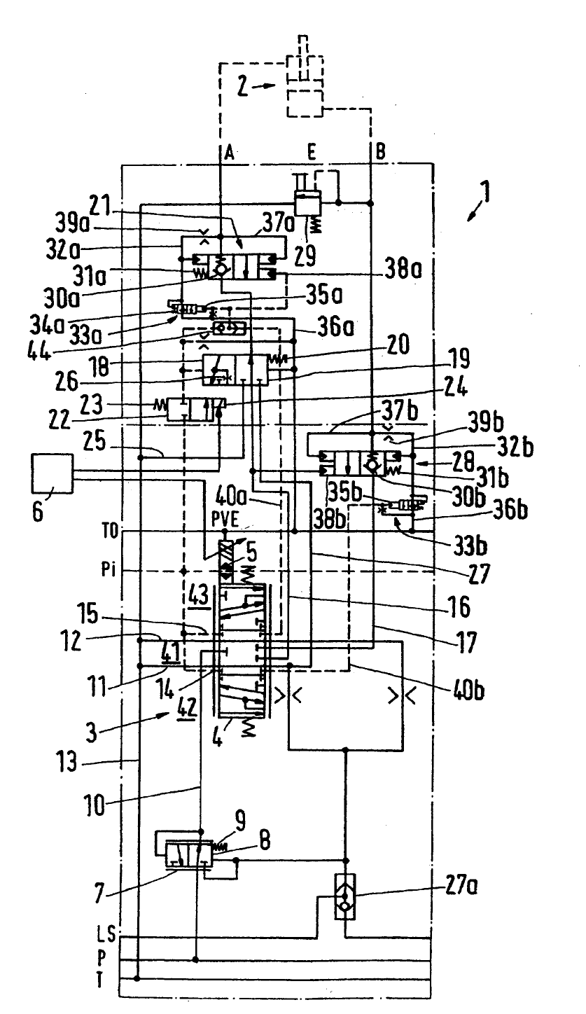

### CROSS-REFERENCE TO RELATED APPLICATIONS

This application is entitled to the benefit of and incorporates by reference essential subject matter disclosed in German Patent Application No. 103 49 714.5 filed on Oct. 23, 2003.

### FIELD OF THE INVENTION

This invention concerns a control device for a hydraulic lifting arrangement with a drive in the form of a hydraulic motor, which has a first working connection and a second working connection, a pressure connection and a tank connection, and a control valve, which is connected with the pressure connection and the tank connection on the one side and with the first working connection via a first working pipe and with the second working connection via a second working pipe, each working pipe comprising a stop valve that can be opened.

### BACKGROUND OF THE INVENTION

Such a control device is known from DE 40 28 887 A1. The two stop valves must ensure that the working connections are tight, that is, without a corresponding activation, no fluid shall be able to leave hydraulic equipment connected with the working connections.

A hydraulic lifting arrangement, which is provided with such a control device, is, for example, used with tractors or other agricultural machines, to lift or lower the “tool bar” or another connecting part, on which agricultural tools can be placed. For many applications, a single-acting drive is sufficient, with which the tool can merely be lifted and is lowered again under the influence of its own gravity. In many cases, however, it is desirable to be able to realise a double-acting operation, in which the drive cannot only generate forces in one direction, but in both directions. Additionally, however, it should also be possible to realise a so-called “floating function”, that is, the parts attached to the lifting arrangement shall be able to lift or lower more or less at random under external influences. For example, a plough attached to the tool bar must be able follow ground ruggedness. In such a float position both working connections are connected with the tank.

With the control device according to the above-mentioned DE 40 28 887 A1, this is only possible with a certain effort. Further to the neutral position and the two working positions, the control valve must be able to assume a fourth position. Additionally, an idling valve is required, which is connected in parallel with the stop valves. With this idling valve, the risk exists again that the control device becomes leaky.

It is an object of the present invention to improve upon or overcome the problems associated with the prior art.

### SUMMARY OF THE INVENTION

The present invention resides in one aspect in a change-over valve arranged in a first working pipe between a control valve and a stop valve, the activation of said change-over valve enabling the opening of the stop valve in the first working pipe.

This embodiment involves several advantages. Firstly, the control device remains tight. The change-over valve does not influence the tightness. The stop valves reliably seal the two working connections. By means of the change-over valve, the change-over from the normal operation to the float position can be effected. Merely fitting the change-over valve can practically enable this change-over function, that is, no large changes of the control valve are required. Thus, a known and proved control valve can be used. The pipes inside the control device can be kept short. No pipes in parallel with the stop valves are required.

It is preferred that the control valve is a three-position valve, particularly a proportional valve. Thus, the control valve can be limited to one neutral position and two working positions, one of the two working connections being supplied with pressurised fluid and fluid being discharged from the other of the two working connections in each working position. The term “position” is of course only to be understood functionally. When the control valve is made as a proportional valve, there will be no stepwise position change. On the contrary, a slide of the proportional valve is displaced in a housing, thus releasing, more or less, control openings, so that the flow of hydraulic fluid can be directed from the pressure connection to the working connection acted upon by pressure. As only three “positions” are required, the accuracy of the valve can, with otherwise unchanged dimensions, be made larger than in an embodiment, which requires four positions. This also improves the control properties of the valve.

Preferably, the stop valves and the change-over valve can be opened hydraulically. This keeps the wear small, as no tappet or the like is required to open the stop valves. Further, the reaction time can be kept small.

Preferably, the change-over valve is connected with a control unit, which takes the control valve to a predetermined position when changing over the change-over valve. Thus, a float position can be achieved automatically when changing over the change-over valve, during which also the control valve is taken to the correct position. Further actions by a user are not required.

It is preferred that the change-over valve has a change-over pilot valve. As soon as the change-over pilot valve is activated, a hydraulic pressure reaches the change-over valve to change its switching position. At the same time, the control valve is controlled, so that it also changes its switching position. Thus a setting of the control device occurs very fast, which permits a floating operation.

It is preferred that the change-over pilot valve is a solenoid valve. A remote control of a solenoid valve can easily be realised. Merely a small hydraulic pressure must be switched, which is large enough for the change-over valve to change its switching position.

Preferably, a pilot valve is allocated to each stop valve, the pilot valve allocated to the stop valve in the working pipe returning fluid being acted upon by a control pressure through the control valve. Thus, it is ensured that the stop valve, which is supposed to permit the passage of the returning fluid, is opened, as soon as the other working pipe is supplied with pressure.

It is also advantageous that each pilot valve is a stop valve that can be opened. As long as the pilot valve has not been activated, it also acts as stop valve, so that no fluid can escape from the tool connected with the working connections through the pilot valve either.

Preferably, the pilot valve of the stop valve in the first working pipe is connected via a shuttle valve with both a control pressure pipe of the control valve and a pressure control pipe for the change-over valve. Thus, in any case, an opening of the stop valve in the first working pipe can be achieved, independently of the operation state requiring this.

It is also advantageous that a pressure in the first working pipe can open the stop valve in the second working pipe. This permits a very fast realisation of the floating position.

### BRIEF DESCRIPTION OF THE DRAWINGS

In the following, the invention is explained in detail on the basis of a preferred embodiment in connection with the sole FIGURE is a schematic view of a control device.

### DETAILED DESCRIPTION OF THE PREFERRED EMBODIMENTS

A control device 1 serves the supply hydraulic motor 2 schematically shown in the sole FIGURE, in the form of a piston-cylinder arrangement. The motor 2 is part of a lifting arrangement, for example those fitted on tractors or other agricultural working machines. Such a lifting arrangement, which is also called a “tool bar”, serves the purpose of carrying tools, which must be lifted or lowered. A typical example of such a tool is a plough, which must be lifted out of the ground at the end of a field to enable the tractor to turn around.

The control device 1 has a first working connection A and a second working connection B. The two working connections are connected with the motor.

Further, the control device 1 has a pressure connection P, a low-pressure connection T and a load-sensing connection LS, as known from hydraulic control devices. Further, a control pressure connection Pi and a tank connection To are provided, tank pressure always ruling at the tank connection To.

A control valve 3 is shown as a proportional valve, whose slide 4 can be displaced by a magnetic drive 5. A control unit 6 controls a magnetic drive 5. The control valve 3 can be a valve type “PVG” available from Sauer-Danfoss ApS, Nordborg, Denmark, however, the present invention is not limited in this regard. Here, it is merely shown as a symbol.

The control valve 3 is connected with the pressure connection P via a control valve 7. The control valve 7 has a slide 8, which is urged by the force of a spring 9 into a position wherein the pressure connection P is connected with the control valve 3. The pressure in a pipe section 10 between the control valve 7 and the control valve 3 acts upon the slide 8 in the opposite direction, so that when the pressure in this pipe section 10 becomes too high the supply of further fluid from the pressure connection P is throttled or even interrupted.

The control valve 3 has two tank connections 11, 12, which are connected with the low-pressure connection T via a tank pipe 13. The control valve also has two control pressure connections 14, 15, which are connected with the control pressure connection Pi. The mentioned pipes and connections 10-12, 14, 15 are on the “inlet side” of the control valve 3.

A first working pipe 16 and a second working pipe 17 are connected with the outlet side of the control valve 3. The two working pipes 16,17 are connected with the two working connections A, B via valves, which will be described below.

In detail, a change-over valve 18 is located in the first working pipe 16 in the flow direction after the control valve 3, said change-over valve 18 having a slide 19, which is positioned by a spring 20 without the occurrence of further forces in such a way that the first working pipe 16 can be passed until reaching a stop valve 21.

To the change-over valve 18 is allocated a change-over pilot valve 22, which is held in the blocked position shown by means of a spring 23. A magnetic drive 24, which is controlled by the control unit 6, is provided to change over the change-over pilot valve 22, so that it releases a connection between the control pressure connection Pi and the side of the slide 19 of the change-over valve 18 opposite the spring 20. When the change-over valve 18 has been changed over, the connection between the control valve 3 and the stop valve 21 at the first working connection A is interrupted. For this purpose, the stop valve 21 is connected with the tank pipe 13 via a pipe 25. A further connection with a throttle 26 then occurs to an LS-pipe 27, which is connected with the load sensing connection LS via a shuttle valve 27a. The load-sensing pipe 27 is also connected with the outlet side of the control valve 3. In the shown neutral position of the slide 4, the load-sensing pipe is connected with the two tank connections 11, 12.

In the second working pipe 17 is located a second stop valve 28. Between the stop valve 28 and the second working connection B, the second working pipe 17 is connected with the tank pipe 13 via an overpressure valve 29.

In principle, the two stop valves 21, 28 have the same design. Therefore, merely the stop valve 21 will be explained. The reference numbers are extended by the index “a”. Corresponding elements in connection with the second stop valve 28 then have the index “b”.

The stop valve 21 comprises a non-return valve 30a, which, in the stop position shown, releases a passage of the first working pipe 16 in the direction of the first working connection A, however, blocking the opposite direction. In order to make the working connection A tight, the non-return valve 30a is made as a seated valve. In order to permit a passage from the working connection A through the stop valve 21 in the direction of the control valve 3, the stop valve 21 must be changed over.

The stop valve 21 is held in the stop position shown by means of a spring 31a. Acting in the direction of the stop position is also the pressure in a pipe 32a, which is connected with the first working connection A via a throttle 39a. This pipe 32a is connected with a pilot valve 33a, which is held in the closed position by a spring 34a. In the opposite direction the pressure at a pressure connection 35a is acting upon the pilot valve 33a. The pilot valve 33a can be switched between the shown stop position, which is realised by a seated valve, and a throughlet position, in which the pipe 32a can be connected with the tank connection T0 via a pipe section 36a. The pilot valve 33a itself is also a stop valve.

The pressure at the first working connection A acts via a pipe 37a upon the stop valve 21 against the force of the spring 31a. Further, a second pressure inlet 38a is connected with the pressure connection 35a of the pilot valve 33a.

In the shown stop position, the same pressure acts upon both sides of the stop valve 21, namely the pressure at the working connection A. When, now, the pilot valve 33a is opened, because a pressure is applied on its pressure connection 35a, fluid flows off via the pipe 32a and generates a pressure drop at the throttle 39a. Then, the pressure in the pipe 32a is lower than the pressure in the pipe 37a. When the pressure difference between the pipes 37a and 32a is so large that it overcomes the force of the spring 31a, the stop valve 21 is opened.

The design of the second stop valve 28 is exactly the same; only, its pressure inlet 38b is connected with the first working pipe 16.

The pressure inlet 35a of the pilot valve 33a of the first stop valve 21 is connected with the control valve 3 via a control pressure pipe 40a. The pressure connection 35b of the pilot valve 33b of the second stop valve 28 is also connected with the control valve 3 via a control pressure pipe 40b.

The control valve 3 has three “switching positions”, namely the neutral position 41 shown in the figure, in which merely the LS-pipe 27 is connected with the tank pipe 13 and all other connections are interrupted; a first working position 42 and a second working position 43. This means that the control valve 3 also works as a directional valve.

When the slide 4 of the control valve 3 is displaced to its first working position 42 (upwards in relation to the drawing), the pressure connection P is connected with the first working pipe 16 via the control valve 7 and the pipe section 10. At the same time, the LS-pipe 27 receives the corresponding pressure from the working connection. The control pressure pipe 40b of the pilot valve 33b of the second stop valve 28 is supplied with control pressure from the control pressure connection Pi. The second working pipe 17 is connected with the tank connection 12. The control pressure pipe 40a of the pilot valve 33a of the first stop valve 21 is not supplied.

In this position 42 of the control valve 3 the second stop valve 28 opens, so that fluid can flow off from the working connection B to the low-pressure connection T. When the change-over valve 18 is in the position shown, also the first working connection A is supplied with pressure, as in this direction the non-return valve 30a is penetrable. The motor 2 is driven in a direction, in which fluid from the working connection B can flow off.

When, in this position 42 of the control valve 3, the change-over valve 18 is activated, the connection between the control valve 3 and the first working connection A is interrupted. Thus, a pressure builds up between the control valve 3 and the change-over valve 18 in the first working pipe 16, which additionally contributes to the opening of the second stop valve 28. However, the pressure is limited, as the control valve 7 closes. When the valve 18 is changed over, a leakage to the tank is generated via the blende or throttle 26, so that also the pressure in the LS-system is limited. Thus, the control valve 7 is prevented from opening to its maximum.

As, for activating the change-over valve 18, the change-over pilot valve 22 has been activated, the control pressure Pi also rules at the pressure connection 35a of the pilot valve 33a of the first stop valve 21, namely through a shuttle valve 44. The higher of the two pressures Pi or the pressure in the control pressure pipe 40a is passed on to the pressure connection 35a by the shuttle valve 44. So, also in this situation the pilot valve 33a is opened by means of the shuttle valve 44, so that the first stop valve 21 is opened. Via the shuttle valve 44 a pressure also acts upon the pressure inlet 38a, so that it is ensured that the stop valve 21 is opened. In this case, a floating position occurs, that is, the motor 2 can move freely. Thus, a load fixed on the motor 2 can be lifted or lowered, without forces being exerted to the motor 2. In both movement directions, the motor 2 can unpreventedly suck in fluid from the low-pressure connection T or discharge fluid to the low-pressure connection T.

In order to realise this floating position, it is expedient when, during change-over of the change-over pilot valve 22, the control unit 6 also displaces the control valve 3 to the position 42.

The pressure admission to the second working connection B takes place similarly. Here, the slide 4 is displaced to the second working position 43, so that the second working pipe 17 is connected with the pressure connection P. The first working pipe 16 is connected with the tank pipe 13. Through the control valve 3, the pressure connection Pi is connected with the control pressure pipe 40a. In this case, fluid reaches the working connection B via the non-return valve 30b of the second stop valve 28. As the first stop valve 21 has been opened via the pilot valve 33a, fluid can flow off from the first working connection A independently of the position of the change-over valve 18. Expediently, however, in such a situation, the change-over valve 18 will be returned to the through-position shown.

Thus, the shuttle valve 44 makes it possible to open the stop valve 21 in the first working pipe 16 in two operation cases: Firstly, it is opened by the pilot valve 33a, when the required pressure is supplied via the control pressure pipe 40a. Secondly, it is opened, when the required pressure is supplied via the change-over pilot valve 22. Thus, with a small effort, both a floating position and a double-acting mode can be realised, even though the control device is tight at both working connections A, B.

1. A control device for a hydraulic lifting arrangement comprising: a drive in the form of a hydraulic motor, having a first working connection and a second working connection, a pressure connection and a tank connection, and a control valve, which is connected with the pressure connection and the tank connection on one side and with the first working connection via a first working pipe and with the second working connection via a second working pipe, each working pipe including a stop valve that can be opened, a change-over valve is arranged in the first working pipe between the control valve and the stop valve, and wherein the activation of the change-over valve enables the opening of the stop valve in the first working pipe.

2. A device according to claim 1, wherein the control valve is a three-position valve, particularly a proportional valve.

3. A device according to claim 1, wherein the stop valves and the change-over valve can be opened hydraulically.

4. A device according to claim 1, wherein the change-over valve is connected with a control unit, which takes the control valve to a predetermined position when changing over the change-over valve.

5. A device according to claim 4, wherein the change-over valve has a change-over pilot valve.

6. A device according to claim 5, wherein the change-over pilot valve is a solenoid valve.

7. A device according to claim 1, wherein a pilot valve is allocated to each stop valve, the pilot valve allocated to the stop valve in the working pipe returning fluid being acted upon by a control pressure through the control valve.

8. A device according to claim 7, wherein each pilot valve is a stop valve that can be opened.

9. A device according to claim 7, wherein the pilot valve of the stop valve in the first working pipe is connected via a shuttle valve with both a control pressure pipe of the control valve and a pressure control pipe for the change-over valve.

10. A device according to claim 1, wherein a pressure in the first working pipe can open the stop valve in the second working pipe.
